(19) United States
(12) Patent Application Publication
(10) Pub. No.: US 2014/0053436 A1
(43) Pub. Date: Feb. 27, 2014

(54) Roller Banners

(71) Applicant: Stuart English, Alnwick (GB)

(72) Inventor: Stuart English, Alnwick (GB)

(73) Assignee: ICONET LIMITED, Alnwick, Northumberland (GB)

(21) Appl. No.: 14/001,348

(22) PCT Filed: Feb. 23, 2012
(86) PCT No.: PCT/EP2012/000778

§ 371 Date: Sep. 12, 2013

(30) Foreign Application Priority Data
Feb. 24, 2011 (GB) 1103196.0

(51) Int. Cl. G09F 17/00; G09F 13/18; G09F 7/18; G09F 13/02

(52) U.S. Cl. CPC G09F 17/00; G09F 13/02; G09F 13/18; G09F 7/18
USPC 40/541; 40/604; 40/600

(57) ABSTRACT

A presentation banner system is provided which is provided with a strip (13, 14) on the reverse side of the banner (3) extending along at least one and preferably both longitudinal edges, the strip (13, 14) enables more accuracy and precise rolling of the banner (3) within its casing (5).

The present invention relates to improvements in or relating to roller banners.

Roller banners are frequently used for promotional activities and consist of advertising or promotional material contained on a banner which, when out of use, is rolled up within a container, usually a cylindrical container to provide an easily transportable item.

In use the banner may be unrolled to expose the promotional material often vertically upwards from the container and is held in place in the viewing position by a retaining means such as a supporting bar. The banner may be spring biased so that when the retaining means is removed the banner will return to the rolled position within the container.

Roller banners provide a common mechanism for storing, transporting and quickly erecting a graphic panel for display purposes.

They typically consist of a sprung roller mechanism held at each end by a plate that forms part of the casing. The spring acts on the plate to create a rotational force on the roller thus when the banner graphic is released from its support it is automatically retracted around the roller.

Banners of this nature are often used at stands at exhibitions, for the provision of advertising materials, in shops and shopping centres and for the display of information in public places and at special events. The design is portable, easy to use, and the base unit in which the presentation is stored becomes the base unit of the banner.

In our International Patent Application PCT/EP2010/006304 we describe means whereby it is possible to link banners together without a gap between the banners. It is also described how the banners when in their display configuration (i.e. extended from the casing) can be held together by the provision of a magnetic strip down the edge of the banner.

A problem with roller banners is that they can be difficult to roll and unroll particularly to roll back for storage after they are released from the display configuration and are under the sometimes too forceful action of the spring rewind. Roller banners have traditionally been made of lightweight materials and as well as being difficult to roll for storage they are also prone to damage particularly during rewind.

We have found that the provision of a strip down one or both sides of the banner facilitates the rolling of the banner into the casing from the display position and furthermore provides strength to the banner.

The present invention therefore provides a roller banner provided with a longitudinal strip at or close to the edge of the banner and extending along one or both of the vertical sides of the banner.

Vertical side refers to the sides of the banner when it is in the display configuration. Strips are preferably provided at both vertical sides and they are preferably provided on the back side of the banner being the side remote from the display material.

The strip may be of any suitable material that provides substance and strength to the edges of the banner and aids in its rolling, typically the strips are from 0.5 mm to 1.5 cm wide. We have found that the strip enables greater control, precision and accuracy in the spring driven rolling of the banner from the display provision. Where two banners are to be placed together in a manner that avoids a gap being formed between the banners the strips on or at the edges of adjacent banners can be used to hold the banners together. The strip or strips may be of magnetic material as is described in International Patent Application PCT/EP2010/006304. This invention is however applicable to single banners as well as multiple banners that may be linked side by side to produce a wide display.

It is preferred to use magnetic strips that extend vertically when the banner is in use and that the strips consist of thin horizontal elements of positive and negative polarity. Such a configuration means that when the banner is rolled away from the display position the positive polarity is drawn to the negative polarity and vice versa facilitating the regular rolling of the banner into the casing. It is preferred that the strips run the full length of the banner when it is in its display position.

Where the invention is used with two or more banners linked together and the strip is of a magnetic material the edges of the banners may be held together by means of one or more magnetic battens extending down the side of the banner and overlapping the magnetic strips on or at the edges of adjacent banners.

The battens will serve to hold the edges together when the banners are in the display configuration. When it is desired to allow the banners to be dissembled and rolled into their containers the battens may be removed; the bases of the banners separated from each other and the banners allowed to roll into their containers and it has been found that the presence of the magnetic strip down the edges of the banner helps to guide the banner into the container ensuring more accurate winding and providing enhanced strength and endurance to the banner.

The invention therefore provides a roller banner providing with a reinforcing strip extending along at least one vertical edge of the banner, preferably the strip extends along both vertical edges of the banner and is preferably on the back side of the banner. The strip is preferably magnetic and is applied by means of an adhesive.

In a further embodiment the invention provides a banner system comprising a roller mounted within a base unit and a banner provided with a reinforcing strip according to the present invention, releasably rolled around the roller. The banner systems may be provided with tensioning devices to allow the tension to support the banner to be varied as required. In a preferred embodiment in which two or more banners are to be attached together the length of the roller is preferably less than the length of the base unit and the width of the banner is the same as the length of the base unit and at least one end of the base unit is provided with an engagement means whereby it can be attached to a second banner system as is described in PCT/EP2010/006304.

The invention further provides a banner carrying display material provided with a reinforcing strip on or near at least one edge at the backside of the banner. The invention may be used with any banner and the banners may be made of any suitable material such as polyester or polypropylene or paper. The reinforcing strip is preferably magnetic.

In a further embodiment the invention further provides two or more such banner systems attached to each other and further provides two or more of such banner systems attached to each other with the banners in their presentation position.

In a preferred embodiment the invention provides a banner system whereby it is possible for multiple banner systems to be connected side by side without gaps between the banners when they are in the presentation position to produce a larger widescreen display. In this embodiment the ends of the base units interlock, with the presentation banner extending further than the edges of the central roller so that the base units can be pushed together to interlock once the presentations are unrolled and fully extended.

Usually base units are pushed together horizontally. When the edges of the banners are held together by battens overlapping the magnetic strips after use of the banner, the latter should be removed and the base units should be detached from each other before retracting the banners. Once the base units are separate the banner may be retracted by pulling the top of the banner up slightly so that it automatically rolls back into the base unit under the power of the retaining coil, in this instance the tension in the banner is determined by the upper tension bar. Alternatively the spring roller itself can determine the tension in the banner. In either embodiment the presence of the strip or strips on the back side of the banner allows greater control of the rewinding operation.

The means for attachment of the base units may be a simple sliding fit or a locking attachment. In a preferred embodiment there is no additional mechanical means required to attach the base units together. They may however be held together magnetically providing a force strong enough to hold them together but which allows them to be readily separated.

The base units are also containers for the roller and they preferably have a flat base to provide stability in use. Where they are to be joined together the base units may be provided with a protrusion at least one end, the protrusion on a first banner system being shaped so that it can receive a protrusion provided on a second banner system for the attachment together of the two systems. In a preferred embodiment the container component of the base unit is cylindrical and provided with a slot for removal and retraction of the banner from and onto the roller. The protrusions at one end of the container may extend partially around the circumference of the container and the second system may be provided with a protrusion shaped to fit into the space provided by a gap in the protrusion around the circumference of the first container to enable the containers to be assembled together.

In a preferred embodiment a first end of the base unit is provided with one attachment means and a second end of the base unit is provided with the means to locate with an attachment means on another base unit corresponding to the attachment means at the first end. This allows a series of banner systems can be assembled with each other in a linear fashion to provide a continuous display derived from a plurality of banners.

The banner systems of the present invention may be provided with lighting that can be used to illuminate the materials displayed by the banner. In the embodiment of the present invention where two or more banners are to be assembled together electrical connections may be provided between the bases of the banners so that a single power supply can power all the lighting which overcomes the cumbersome need for separate power supplies to each of the banners. In a preferred embodiment the lighting may be in the form of a strip of light elements that can be adhered to the base of the banner and projected in the required direction. Alternatively or in addition the power can be routed to elsewhere on the banner to provide any desirable visible effect. For example, it may be routed to the top of the banner to permit downward lighting onto the display material.

A preferred banner system according to the invention comprises
i) a roller to which the presentation banner may be secured and releasably wound around.
ii) a spring based coiling mechanism which will act to retract the banner when it is released from its display position.
iii) a support to retain the banner in its display position.
iv) a base unit for containing the roller and the spring based coiling mechanism the base unit being provided with a slot for withdrawal of the banner from the roller into the display position or retraction of the banner back onto the roller for storage and transportation.
v) a banner that is provided with a reinforcing strip extending along or close to both vertical edges of the banner preferably on the back side of the banner.

The base unit preferably has a flat base to hold the banner steady when in the display position; and has a cylindrical section to house the roller with the banner around it when it is in the storage position. In the embodiment where two or more banners are to be joined together the container may be provided with attachment means at each end, the attachment means at the first end being shaped to engage with the attachment means at the second end so that two or more base units may be integrated with each other. The support means for holding the banner in the display mode is preferably releasably attached to the base unit typically to the centre of the base unit but can be removed from the base unit for storage and transportation. The support means can, if desired, be telescopic.

According to an embodiment of the invention the base unit including protrusions acting as engagement means is longer than the roller and the width of the banner is substantially the same as the length of the base unit. In this way two (or more) base units may be assembled together without the rollers of the units interfering with each other and the banners may be brought into the presentation mode independently of each other with their edges touching to provide a continuous display bridging two or more banners.

The invention further allows the material of individual banners to be interchanged without the need to disrupt the entire display.

When preparing a display of two or more banners employing the techniques previously described the individual banners should be rolled out into viewing position before the neighbouring banner units are connected to each other. Similarly linked banner units must be separated before the banners can be retracted onto the sprung roller. This is because, in order to get the base units to link, the space used by the rolled up banner beyond the length of the roller when in the storage position must be free to receive the attachment means of the neighbouring base unit. In a further embodiment lighting may be provided along the base units to illuminate the material carried by the banner. It is preferred that where two or more banners are linked together electrical connections between the banners are provided to enable a single power supply to power all the lighting.

In a further embodiment the banner or banners may be slightly narrower at the end adjacent to the roller when the banners are in the display position so that the banner does not interfere with the joining of the base units.

Thus according to this invention one or both edges of the banner are provided with a strip of reinforcing material to improve and control the winding and unwinding of the banner. In particular the edge of the banner may be provided with a magnetic strip of appropriate size and strength to ensure that the banner can be rolled within the casing on the roller in a compact manner and can also be readily released there from. The banners may also be provided with strips at their edges to hold them together in the mounted position. For example the strips may be magnetic and held together by magnetic battens which overlap the magnetic strips.

The invention is illustrated by reference to the accompanying drawings in which

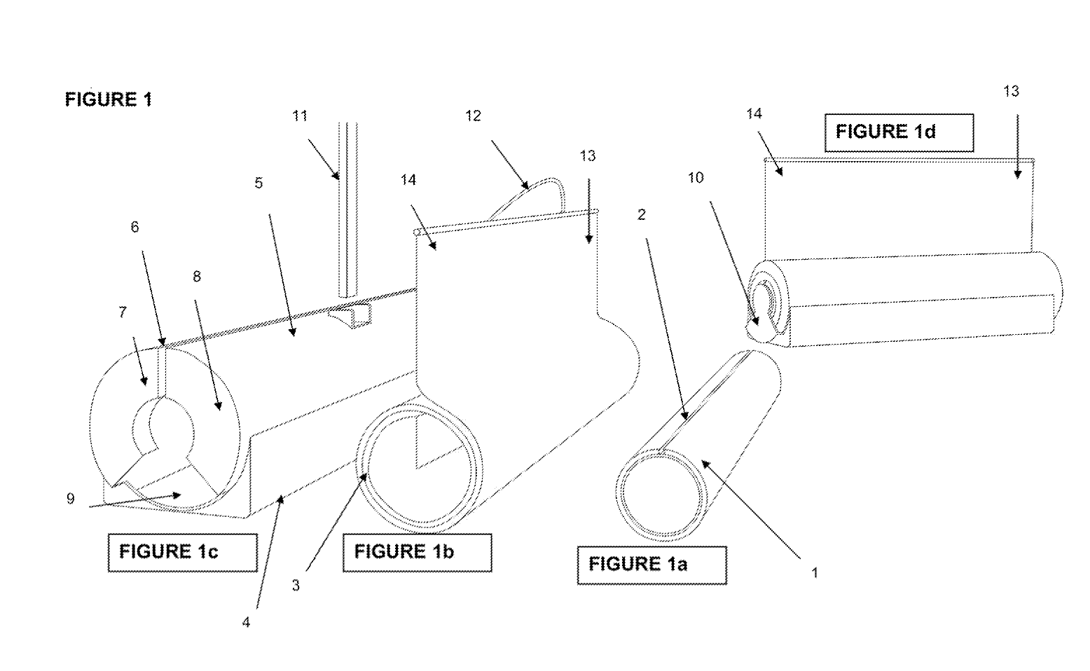

FIG. 1 shows the components of a banner system according to the invention.

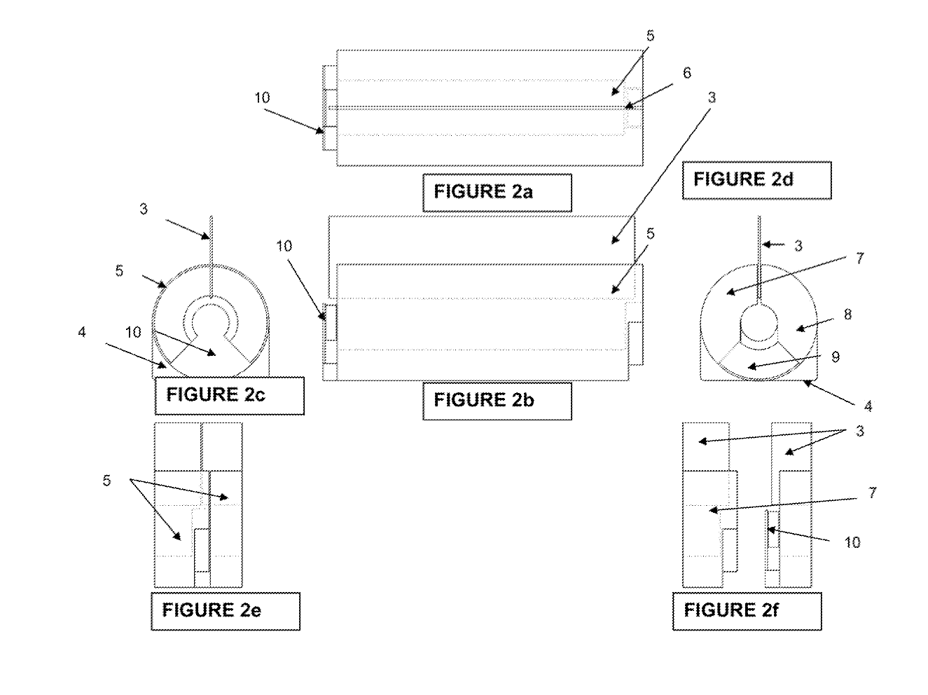

FIG. 2 shows the attachment mechanism provided on a base unit of a banner for joining together two systems as shown in FIG. 1

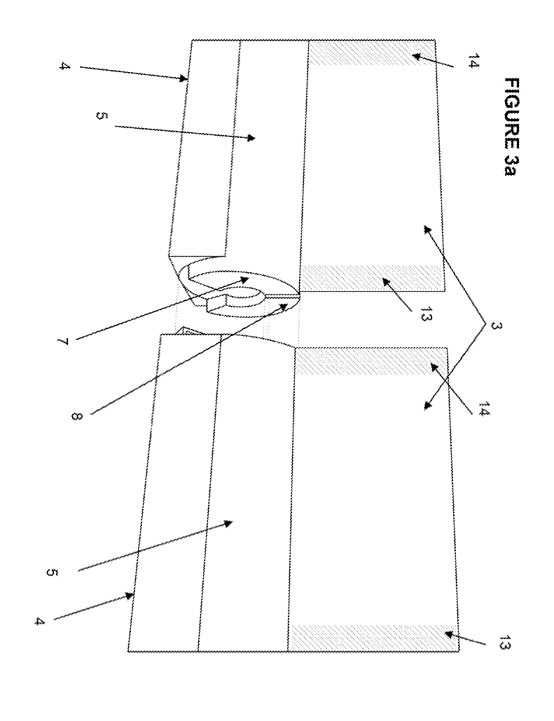

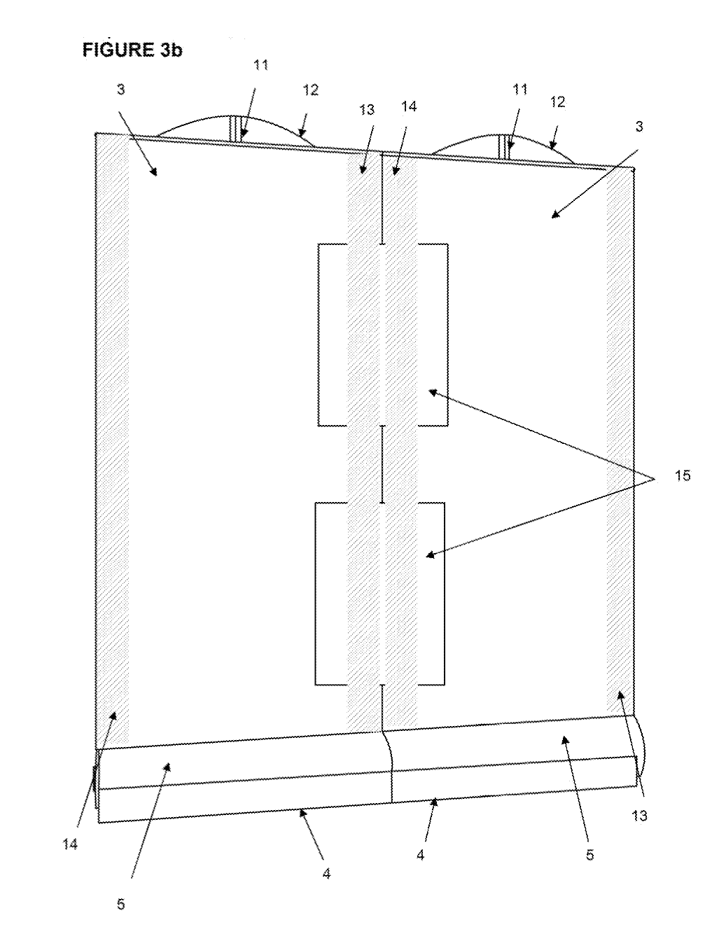

FIG. 3 shows two banner systems of the type shown in FIGS. 1 and 2 ready for assembly and FIG. 4 shows them attached to each other with the banners in the presentation position.

FIG. 1a shows a central roller (1) provided with a slot (2) to which a banner can be attached.

FIG. 1b shows a banner (3) in the rolled position as if it was retained by the roller.

FIG. 1c shows a base unit provided with a flat base (4) containing a cylindrical housing (5) provided with a slot (6) through which the banner (3) can pass.

The base unit is provided with a protrusion (7) and (8) which provide a means of assembly to a matching protrusion (9) in a second base unit. It is also preferred that a matching protrusion be provided at the other end of the container as shown by (10) in FIG. 1d. FIG. 1c also shows the support (11) that may be used to hold the banner in the presentation position by linking the loop (12) shown in FIG. 1(b) over the top of the support (not shown). The banner is biased back into the container and around the roller by a spring coiling mechanism (not shown). The banner is provided with magnetic strips (13) and (14) at its edges to aid rolling and unrolling and to help secure two or more banners together when that is required.

FIG. 2 shows various elevations of the base unit shown in FIG. 1(c) and like numerals are used for the like items in FIG. 1.

FIG. 2a is a top elevation of the housing, FIG. 2b is a front elevation of the housing. FIG. 2c is a left handed end view of the housing. FIG. 2d is a right hand end view of the housing. FIG. 2e shows two housings interlinked with each other and FIG. 2f shows interlinkable housings detached from each other.

FIG. 3a shows two banner systems as shown in FIG. 1 adjacent to each other and ready to extend the banner into the presentation position and ready for assembly.

FIG. 3b shows the two banner systems of FIG. 3a with the banners extended and two of the banner systems assembled together with magnetic battens (15) bridging the adjoining magnetic strips to hold the banners together.

1. A roller banner provided with a longitudinal strip at or close to the edge of the banner and extending along one or both of the vertical sides of the banner,

2. A roller banner according to claim 1 in which strips are provided at both vertical sides.

3. A roller banner according to claim 1 in which the strips are provided on the side of the banner remote from the display material.

4. A roller banner according to claim 2 in which the strips are from 0.5 mm to 1.5 cm wide.

5. A roller banner according to claim 2 in which the strips are magnetic strips.

6. A roller banner according to claim 2 in which the strips run the full length of the banner when it is in its display position.

7. A roller banner according to claim 1 wherein two or more banners are linked together and the strip is of a magnetic material and the edges of the banners are held together by means of one or more magnetic battens extending down the side of the banner and overlapping the magnetic strips.

8. A banner system according to claim 1 comprising a roller mounted within a base unit and a banner provided with a reinforcing strip.

9. A banner system comprising two or more banners according to claim 8 attached together wherein the length of the roller is less than the length of the base unit and the width of the banner is the same as the length of the base unit and at least one end of the base unit is provided with an engagement means whereby it can be attached to a second banner system.

10. Two or more banner systems according to claim 9 attached to each other

11. Two or more of banner systems according to claim 10 attached to each other and with the banners in their presentation position.

12. A banner system according to claim 1 provided with lighting that can be used to illuminate the materials displayed by the banner.

13. A banner system according to claim 12 wherein two or more banners are assembled together and electrical connections are provided between the bases of the banners.

14. A banner system according to claim 12 wherein the lighting is in the form of a strip of light elements that can be adhered to the base of the banner.

15. A banner system according to claim 12 wherein electric power is routed to elsewhere on the banner, for example, to the top of the banner to permit incidence of downward light onto the display material.

16. A banner system according to claim 15 wherein electric power is routed to the top of the banner to permit incidence of downward light onto the display material.

17. A roller banner provided with a longitudinal strip at or close to the edge of the banner and extending along one or both of the vertical sides of the banner with lighting that can be used to illuminate the materials displayed by the banner.
